(19) United States
(12) Patent Application Publication
(10) Pub. No.: US 2013/0017085 A1
(43) Pub. Date: Jan. 17, 2013

(54) WIND TURBINE WITH ANTI-ROTATIONAL LOCKING MECHANISM, THRUST CHANNELS, AND BLADE TIP WINGLETS

(71) Applicant: Ralph A. Belden, Minden, NV (US)

(72) Inventor: Ralph A. Belden, Minden, NV (US)

(73) Assignee: GLOBAL SUN WIND & POWER CORP

(21) Appl. No.: 13/184,389

(22) Filed: Jul. 15, 2011

(51) Int. Cl. F03D 1/00

(52) U.S. Cl. 416/9

(57) ABSTRACT

A wind turbine includes a base, a support member rotatably mounted to the base, an elongate body having a first end and a second end, the body pivotally mounted to a distal end of the support member at a pivot point that is offset from the axis of the base. A rotor blade assembly is coupled to a rotor shaft rotatably mounted to the top of the body and includes a plurality of rotor blades. A tail assembly is mounted to the second end of the elongate body and includes an airfoil section and at least one upright vane having a rudder with an angular offset. An alternator is coupled to the rotor shaft. An annular ratchet is disposed on the base. A flag and pawl assembly is pivotally coupled to a proximal end of the support member.

### BACKGROUND OF THE INVENTION

1. Field of the Invention

The present invention relates to wind turbines. More particularly, the present invention relates to wind turbines that can self-orient themselves in response to drastic changes in wind velocity or direction using only natural forces.

2. The Prior Art

Wind turbines are known in the prior art. Wind turbine design strategies are typically focused on overcoming one or two of three common design challenges. First, a small minority of prior designs have attempted to achieve the aerodynamic characteristics needed to harness meaningful amounts of energy from low velocity winds—winds that cover over 85% of the surface of the earth. Second, some designs have strived to implement governing mechanisms that automatically protect the turbine from extremely high velocity winds—winds that place massive stress on the structural integrity of a turbine—without sacrificing the ability to deliver a constant power output. Every wind turbine that utilizes rotor blades has a rotor shaft. A vertically governed wind turbine moves the axis of rotation of its rotor shaft from a horizontal to vertical orientation. A horizontally governed wind turbine moves the axis of rotation of its rotor shaft within a horizontal plane. Lastly, some designs have sought to limit the gyroscopic movements arising from drastic changes in wind velocity or direction that disorient a turbine and ultimately disrupt its power output efficiency by horizontally orienting the axis of its rotor shaft. Although no single prior design has provided optimal solutions to all three problems, many have attempted to incorporate solutions to one or two of these issues at a time.

Foremost, most previously known wind turbines lack the aerodynamic characteristics needed to harness meaningful amounts of energy from low velocity winds. Accordingly, nearly all existing commercial wind turbines are designed for use in the few geographic regions around the globe that regularly experience high velocity winds. U.S. Pat. Nos. 4,449,889 and 5,295,793 constitute a small minority of patents that disclose wind turbines that are specifically suited for use in low velocity winds. As discussed later in further detail, the present invention improves significantly on these prior designs.

Additionally, it has been suggested that the aerodynamic deficiency issues may be solved by applying vortex generating technologies to rotor blade design. U.S. Pat. No. 7,832,689 discloses a system of passive fluid jet vortex generating outlets. Although effective, such outlets impose constraints on rotor blade design. Because they rely on generating swirling vortices, the outlets only function when spaced close enough to interact with one another, but not so close as to interfere with one another.

Moreover, such outlets are best suited for enhancing the lift properties of rotor blades that are already rotating rather than for obtaining start-up momentum in low velocity winds. Specifically, they run from edge to edge in a direction parallel to the plane of the blade. Because a wind turbine needs to capture as much wind as possible to obtain any meaningful rotational speed in low velocity winds, it must expose as much rotor blade surface area to the wind as possible. Given that the outlets disclosed in U.S. Pat. No. 7,832,689 run from edge to edge, their inlets are optimized for receiving incoming wind when the rotor blades have already picked up rotational speed and are slightly angled rather than when resting perpendicular to the ground.

Other vortex generating technologies are also generally known in the art. For example, U.S. Pat. No. 4,455,045 discloses a set of vortex generating channels that rely on the sharp edges of “V-shaped” ramps to create swirling vortices. Such generators are optimized for reducing drag in automobile designs.

In addition to addressing aerodynamic deficiencies, some prior wind turbine designs have attempted to quell the excessive stress forces that high velocity winds place on the structural integrity of a wind turbine. The force placed on a wind turbine increases in proportion to the area of the rotor blades multiplied by the wind velocity cubed. As a result, assuming that the area of the rotor blades exposed to the wind remains constant, a 60 mph gust subjects a turbine to eight times the force than that imposed by a 30 mph gust. Such forces can drive movable components beyond their design limits and result in mechanical breakdown.

In response to such issues, prior designs have incorporated governing mechanisms that automatically reduce the exposed rotor blade area when the wind exceeds a certain velocity. Some designs reduce rotor blade exposure by allowing the rotor assembly to tilt vertically. Examples of such designs are disclosed in U.S. Pat. Nos. 4,449,889 and 5,295,793. The present invention improves significantly on these prior designs by adding additional safety mechanisms.

Similarly, horizontally governed wind turbines reduce rotor blade exposure by allowing the rotor assembly to rotate horizontally. Notably, however, because horizontally governed turbines—unlike those that are vertically governed—do not directly oppose gravity, they typically experience difficulty re-orienting back into the wind. Some previously known turbines rotate so much that they must be manually reset after effectively shutting down in order to save the machine Because such turbines experience time periods in which the rotor shaft is not spinning at a constant angular velocity, they struggle to deliver a consistent power output.

Some horizontally governed wind turbines known in the prior art have attempted to solve such efficiency problems by biasing the horizontal axis of the rotor assembly in some way. For example, U.S. Pat. No. 5,746,576 discloses a wind turbine design in which the rotor assembly is slightly inclined and swivels on a mechanical pivot point. Similarly, U.S. Pat. No. 7,915,751 discloses a design in which the rotor assembly flexes to the side on an elastic rod. Although horizontal governing mechanisms reduce rotor blade exposure, they generally cannot do so as effectively as vertical governing mechanisms. Specifically, while a vertically governed turbine can reduce rotor blade exposure nearly to zero by lifting the surface of its blades parallel to an oncoming airstream, a horizontally governed turbine cannot rotate enough to achieve such an effect without sacrificing its ability to re-orient.

Additionally, vertically governed wind turbine designs are optimized for using supplemental safety mechanisms like blade tip winglets. Blade tip winglets are generally known in the prior art. For example, U.S. Pat. No. 7,931,444 B2 discloses an inclined winglet at the outer edges of the blades that can be used to improve overall turbine performance and reduce noise emissions. The height of these winglets is significant and they are best suited for reducing tip drag in designs in which the rotor blades are always perpendicular to the ground.

Notably, however, because a vertically governed turbine functions by lifting the exposed surface area of its rotor blades parallel to the oncoming airstream, such blade tip winglets are less suited for use in such turbines. Specifically, when such a turbine that has blades that are equipped with such winglets is titled such that its blades are parallel to the airstream, the blade tip winglets present too much surface area perpendicular to the wind, thus tending to rotate the blades out of their nominal plane of rotation. On the one hand, if the winglets are nearly perpendicular, they can interfere with the ability of a turbine to provide lift to its rotor blades in response to dangerously high velocity winds. On the other hand, if the winglets are less sharply inclined, their excessive height can create excessive lift and risk hyper-extending the rotor assembly.

Furthermore, prior wind turbine designs have also attempted to limit gyroscopic movements arising from drastic changes in wind velocity or direction that disorient the turbine and ultimately disrupt its power efficiency. When the wind velocity abruptly drops or the wind suddenly changes direction, a vertically governed wind turbine experiences a destabilizing gyroscopic torque that stems from the rapidly slowing yet still rotating rotor blades. Such torque causes the entire structure to precess and turn away from the wind. Previously known vertically governed wind turbines lack mechanisms for preventing such movement. Accordingly, rather than preventing the precession in the first place, they require that the turbine wait until the wind changes directions in such a way that it passively re-orients the machine back into the wind. Such movements ultimately reduce power output efficiencies.

Moreover, prior known designs like those disclosed in U.S. Pat. Nos. 6,974,307 B2, 5,746,576 and 7,915,751 have attempted to address this issue by utilizing a horizontal governing mechanism that is not susceptible to precession around a vertical axis. As previously mentioned, however, such mechanisms limit the ability of a wind turbine to reduce rotor blade exposure to nearly zero. In short, no previously existing designs have successfully combined the ability of a vertically governed wind turbine to reduce rotor blade surface area with the anti-rotational benefits of a horizontally governed turbine.

### BRIEF DESCRIPTION OF THE INVENTION

According to a first aspect of the present invention, a wind turbine includes a base and a support member mounted to the base. The support member is mounted such that it rotates horizontally around the axis of the base. An elongate body with a first and second end is mounted to the distal end of the support member at a pivot point. The body is mounted such that it tilts vertically in a position offset from the axis of the base.

A rotor blade assembly is coupled to a rotor shaft. The rotor shaft is mounted to the top of the body such that it rotates around its own axis. The rotor blade assembly includes a plurality of blades and is oriented to rotate when exposed to an airstream generated by wind. An alternator is coupled to the rotor shaft. The power output of the alternator varies as a function of the angular velocity of the rotor shaft.

A tail assembly is mounted to the second end of the body. The tail assembly includes both an airfoil section oriented perpendicular to the rotor shaft and at least one upright vane. The vane passively rotates the body into the direction of the wind in response to an airstream. The vane features an angular rudder offset to generate wind-induced torque in a direction opposite to the gyroscopic torque generated by rotation of the rotor blade assembly.

The pivot point is located at a position along the length of the body such that the turbine achieves a particular weight balance. According to such balance, when an airstream exerts a force on the airfoil section of the tail assembly, the body tilts about the pivot point and effectively changes the cross-sectional area of the rotor blades exposed to the airstream such that the rotor shaft rotates at a substantially constant angular velocity.

An annular ratchet is mounted to the top of the base. The ratchet includes a plurality of ratchet teeth, each of which has a flat side and a slanted side. A flag assembly is pivotally coupled to a proximal end of the support member such that it can rotate around the axis of the base in two directions: a restricted direction and an unrestricted direction. The flag assembly includes a control vane mounted to a distal end of an angled extension shaft and a pawl mounted to a proximal end of the extension shaft. The control vane has a front-side and a back-side and is sized as a function of the scale of the overall turbine such that the vane can capture enough wind to engage or disengage the pawl with the flat side of the ratchet teeth.

When the wind rotates the body in the restricted direction, the pawl is stopped by the flat side of the ratchet teeth unless the pawl is disengaged from the ratchet. When the wind rotates the body in the unrestricted direction, the pawl passes freely over the slanted sides of the successive ratchet teeth. The flag assembly, support member, and ratchet function together as a self-regulated anti-rotational locking mechanism that prevents the body from precessing like a top and ultimately turning away from the wind in response to an abrupt change in wind velocity or direction.

According to a second aspect of the present invention, the rotor blade assembly includes at least two rotor blades that have one or more tapered bores running between their top and bottom surfaces. Such bores effectively serve as thrust channels. Each bore is oriented at an angle such that it independently creates a thrust tending to rotate the blade by passively compressing the airstream as it passes through the blade in a straight line.

According to a third aspect of the present invention, each rotor blade features a short inclined distal region that effectively serves as a blade tip winglet. Namely, the inclined distal region provides additional lift when the turbine tilts its rotor blades parallel to the ground in response to high velocity winds.

### BRIEF DESCRIPTION OF THE DRAWING FIGURES

FIG. 1 is a side view of an apparatus according to an exemplary embodiment of the present invention experiencing high velocity winds.

FIG. 2 a top view of the apparatus of FIG. 1.

FIG. 3 is a side view of an apparatus according to an alternate exemplary embodiment of the present invention experiencing low velocity winds.

FIG. 4 is a more detailed side view of the apparatus of FIG. 3.

FIG. 5 is an exploded view of an apparatus according to an exemplary embodiment of the anti-rotational locking system included in the apparatus of FIG. 4.

FIG. 6a is a detailed top view of the apparatus of FIG. 5 operating when faced into the wind.

FIG. 6b is a detailed top view of the apparatus of FIG. 5 operating when faced to the left of the wind.

FIG. 6c is a detailed top view of the apparatus of FIG. 5 operating when faced to the right of the wind.

FIG. 7 is a perspective view of an apparatus according to an exemplary embodiment of a rotor blade included in the apparatus of FIG. 1.

FIG. 8 is a cross-sectional view of the apparatus of FIG. 7.

### DETAILED DESCRIPTION OF THE INVENTION

Persons of ordinary skill in the art will realize that the following description of the present invention is illustrative only and not in any way limiting. Other embodiments of the invention will readily suggest themselves to such skilled persons.

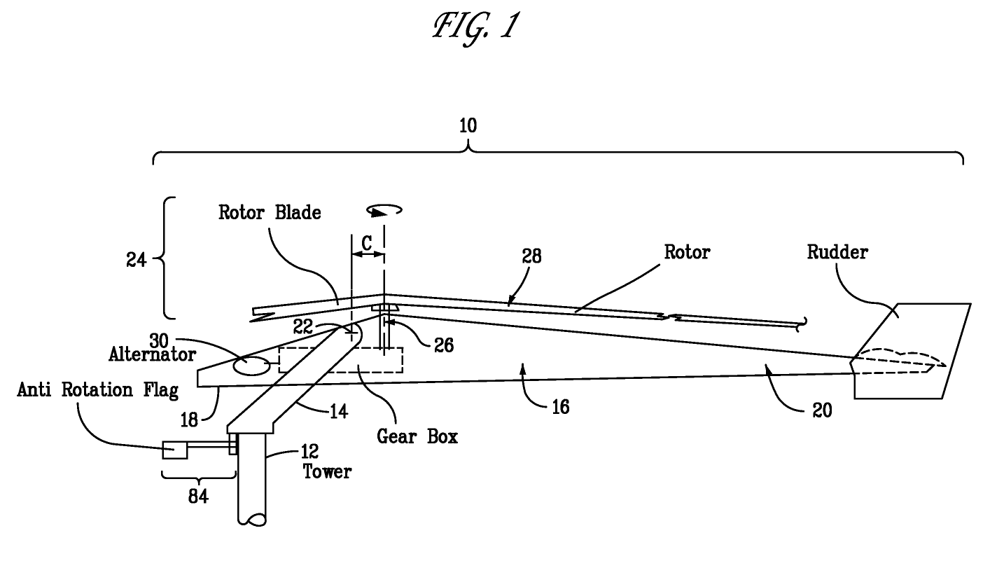

Referring first to FIG. 1, an exemplary embodiment of the present invention provides a wind turbine 10 that includes a base 12 and a support member 14 mounted to the base 12. The support member 14 is mounted such that it rotates horizontally around the axis of the base 12. An elongate body 16 with a first end 18 and second end 20 is mounted to the distal end of the support member 14 at a pivot point 22. The body 16 is mounted such that it tilts vertically in a position offset from the axis of the base 12. In an exemplary embodiment, the body 16 tilts about 90° from a substantially vertical orientation.

A rotor blade assembly 24 is coupled to a rotor shaft 26. The rotor shaft 26 is mounted to the top of the body 16 such that it rotates around its own axis. The rotor blade assembly 24 includes a plurality of blades 28 and is oriented to rotate when exposed to an airstream generated by wind. Each rotor blade 28 is mounted at a negative angle of attack. In an exemplary embodiment, the outer blade-to-blade angle is between about 180° to about 185°. In other embodiments, other blade-to-blade angles above about 180° may be used. Moreover, in an exemplary embodiment, the number of blades 28 may be three. In other embodiments, other numbers of blades 28 may be employed. An alternator 30 is coupled to the rotor shaft 26. The power output of the alternator 30 varies as a function of the angular velocity of the shaft 26.

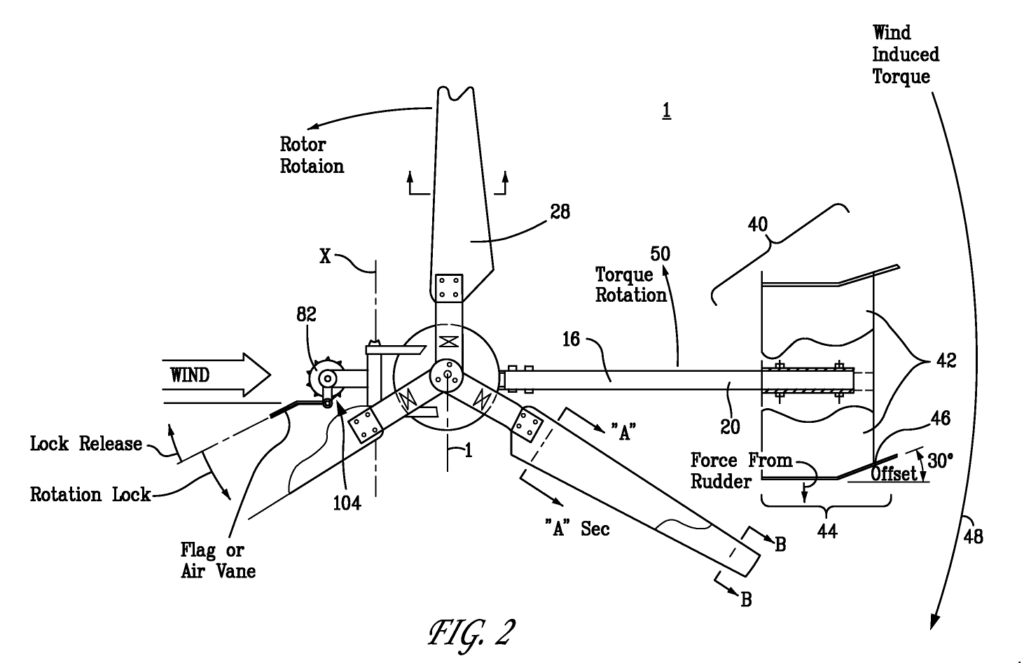

Referring now to FIG. 2, a tail assembly 40 is mounted to the second end 20 of the body 16. The tail assembly 40 includes both an airfoil section 42 oriented perpendicular to the rotor shaft 26 and at least one upright vane 44. The vane 44 features an angular rudder 46 offset to generate wind-induced torque 48 in a direction opposite to the gyroscopic torque 50 generated by rotation of the rotor blade assembly 24. According to an exemplary embodiment, the tail assembly 40 includes two upright vanes 44, each featuring an angular rudder 46 that has an offset of about 30°.

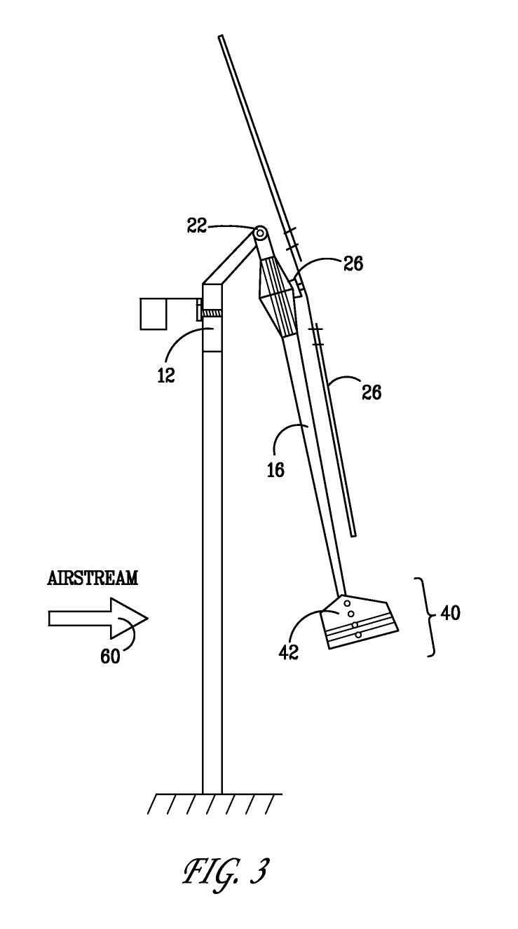

Referring now to FIG. 3, it may be seen that the pivot point 22 is located at a position along the length of the body 16 such that it achieves a weight balance as will be further described herein. According to such balance, when an airstream 60 exerts a force on the airfoil section 42 of the tail assembly 40, the body 16 tilts about the pivot point 22 and changes the cross-sectional area of the rotor blades 28 exposed to the airstream 60 only so much as necessary to keep the rotor shaft 26 rotating at a substantially constant angular velocity. According to one embodiment, as further illustrated in FIG. 3, this weight balance may not require that the body 16 extend beyond the pivot point 22. Conversely, according to an alternate embodiment shown in FIG. 1, this weight balance may require that the body 16 extend beyond the pivot point 22 to assist in counter-weighting the tail assembly 40. Persons ordinarily skilled in the art will recognize that the location of the pivot point 22 required to achieve this weight balance will depend on numerous factors such as the weight distribution of the body 16 and the weight and location of the other components. Choosing such a location requires the exercise of routine skills known by those ordinarily skilled in the mechanical arts.

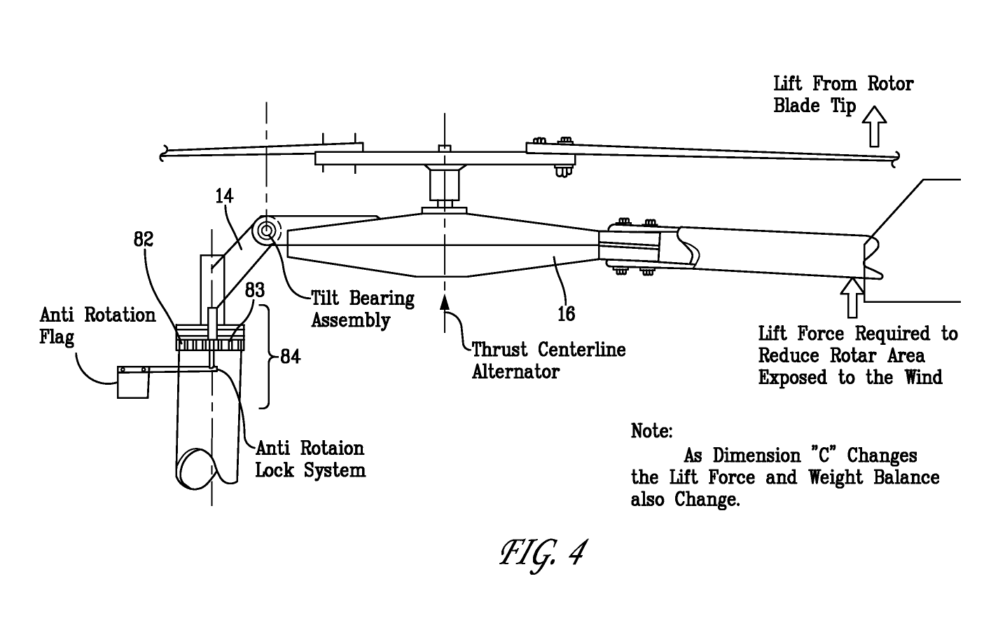

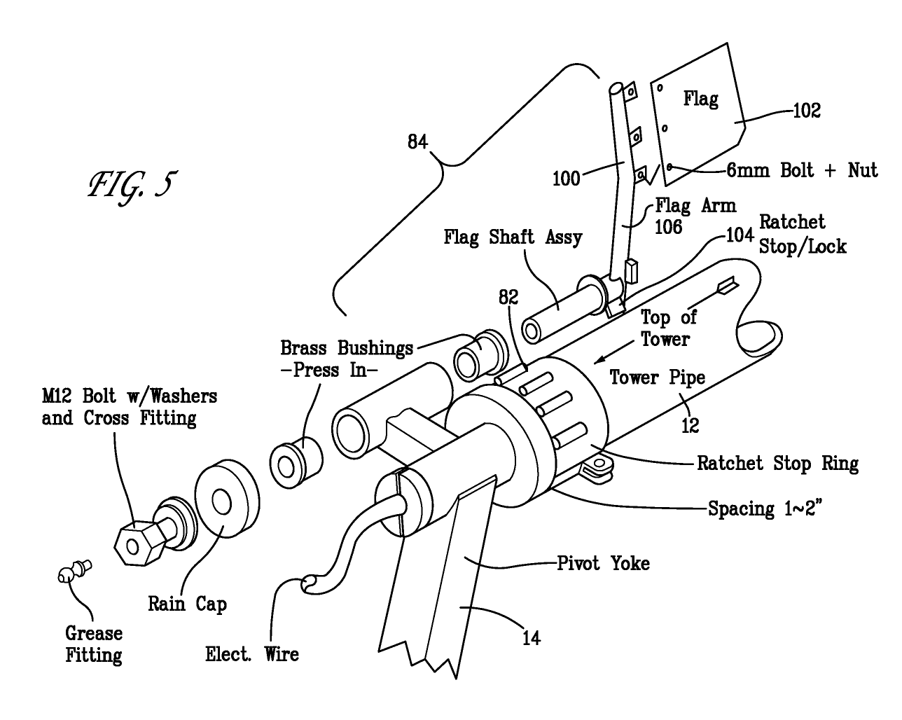

Referring now to FIG. 4, an annular ratchet 82 (also shown in FIG. 2) is mounted to the top of the base 12. The ratchet 82 includes a plurality of ratchet teeth 83, each of which has a flat side and a slanted side. A flag assembly 84 (also shown in FIG. 1) is pivotally coupled to a proximal end of the support member 14 such that it can rotate around the axis of the base 12 in two directions: a restricted direction and an unrestricted direction. The flag assembly 84, support member 14, and ratchet 82 function together as a self-regulated anti-rotational locking mechanism that prevents the body 16 from precessing like a top and ultimately turning away from the wind in response to an abrupt change in wind velocity or direction. The anti-rotational locking mechanism is assembled as known by those ordinarily skilled in the art using commonly employed components such as nuts, bolts, and bushings as depicted in FIG. 5.

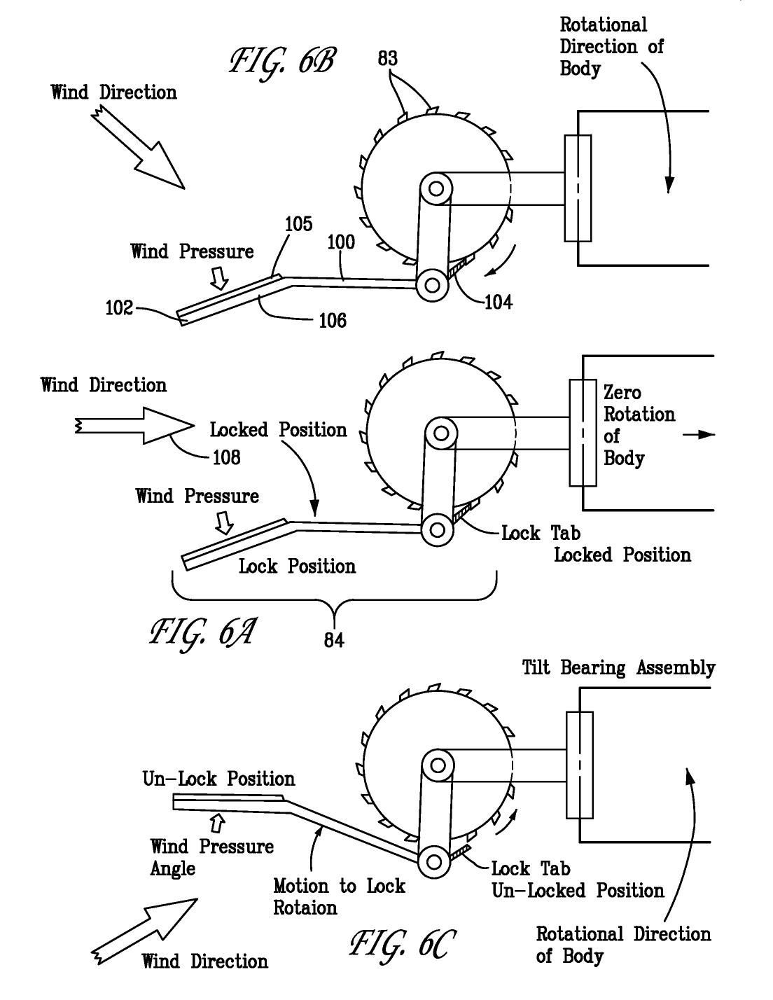

As shown in further detail in FIG. 6, the flag assembly 84 includes a control vane 102 mounted to a distal end of an angled extension shaft 100 and a pawl 104 (also shown in FIG. 2) mounted to a proximal end of the extension shaft 100. The control vane 102 has a front-side 105 and a back-side 106 and is sized as a function of the scale of the overall turbine to enable that the vane to capture enough wind to engage or disengage the pawl 104 with the flat side of the ratchet teeth. As mentioned, the flag assembly 84 can rotate around the axis of the base 12 in two directions: a restricted direction and an unrestricted direction. In the restricted direction (as seen in FIGS. 6a and 6c), the pawl 104 is stopped by the flat side of the ratchet teeth 83 unless the pawl 104 is disengaged from the ratchet 82. Conversely, in the unrestricted direction (as seen in FIG. 6b), the pawl 104 passes freely over the slanted sides of the successive ratchet teeth 83.

As shown in FIG. 6a, when the turbine is faced into the wind, the airstream 108 strikes the front-side 105 of the control vane 102. In striking the front-side 105, the airstream 108 exerts torque on the shaft 100. In response to such torque, the shaft 100 engages the pawl 104 with the flat side of the ratchet teeth 83. Moreover, because the turbine is faced into the wind (as shown in FIG. 6a), the upright vane 44 of its tail assembly 40 rests parallel to the oncoming airstream 108. As a result, when the airstream 108 hits the turbine head-on, it causes the flag assembly 84 to effectively lock the ratchet without placing any counter-torque on the tail assembly 40 that would otherwise overpower the flag assembly 84. Accordingly, when the turbine properly faces into the wind (as shown in FIG. 6a), it effectively remains locked in that direction until it needs to re-orient itself.

Conversely, as shown in FIG. 6b, when the turbine faces to the left of the wind—because the wind suddenly changed velocity or direction and caused the turbine to precess—the airstream 108 places counter-torque on the tail assembly 40. Although the airstream 108 again strikes the front-side 105 of the control vane 102 and urges the pawl 104 into contact with the slanted side of the ratchet teeth 83, this time the prevailing counter-torque causes the turbine to rotate in the unrestricted direction. Because the turbine is rotating in the unrestricted direction, the pawl 104 does not contact the flat side of the ratchet teeth 83. Rather, the pawl 104 merely contacts the slanted sides of the successive ratchet teeth 83 as the body rotates in the unrestricted direction. Accordingly, when the turbine faces to the left of the wind (as shown in FIG. 6b), it effectively self-orients itself back into the wind by rotating in the unrestricted direction.

Similarly, the turbine is likewise free to self-orient itself by rotating in the restricted direction when, as shown in FIG. 6c, the turbine faces to the right of the wind. In such a case, the airstream 108 strikes the back-side 106 of the control vane 102. In striking the back-side 104, the airstream 108 exerts torque on the extension shaft 100 in a direction opposite to that exerted in FIGS. 6a and 6b. In response to such torque, the shaft 100 disengages the pawl 104 from contact the flat side of the ratchet teeth 83. Because the turbine is faced to the right of the wind (as shown in FIG. 6c), the upright vane 44 of its tail assembly 40 does not rest parallel to the oncoming airstream 108. As a result, the airstream 108 pushes the tail assembly 40 in the restricted direction. Because the pawl 104 is disengaged from the ratchet 82, the turbine is free to rotate in the restricted direction. Accordingly, when the turbine faces to the right of the wind (as shown in FIG. 6c), it effectively self-orients itself back into the wind by rotating in the restricted direction.

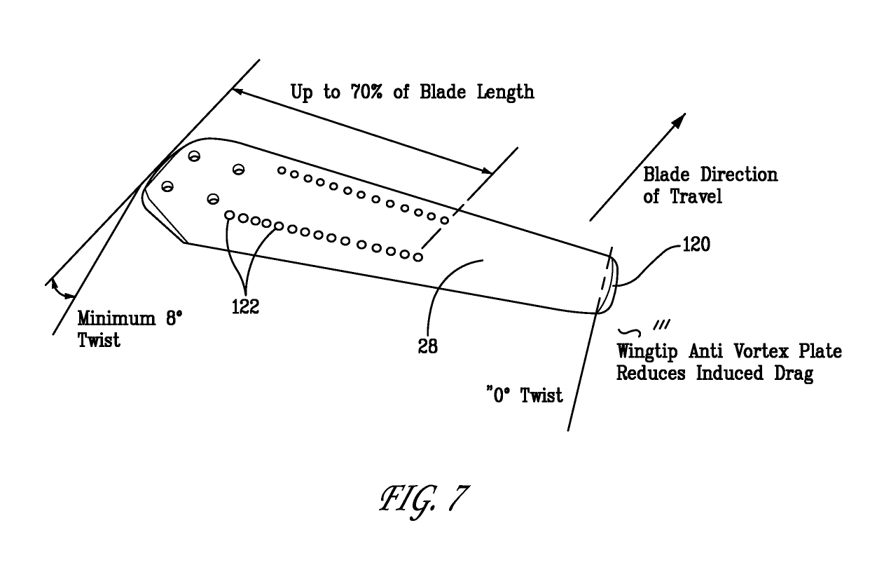

According to another exemplary embodiment, as shown in FIG. 7, each rotor blade 28 features an inclined distal region 120 that serves a blade tip winglet. The inclined distal region 120 has a height of up to 12% of the length of the tip chord and an angle of attack of about 30° above the plane of the blade 56.

Moreover, likewise shown in FIG. 7, each rotor blade 28 preferably incorporates a progressive negative twist starting from about 8° to 30° at the proximal end of the blade 28 and reaching about 0° at the distal end of the blade 28. Those ordinarily skilled in the art will recognize that the progressive negative twist enhances the lift properties of the rotor blades 28. Such properties are useful for gaining initial rotational momentum at low wind velocities.

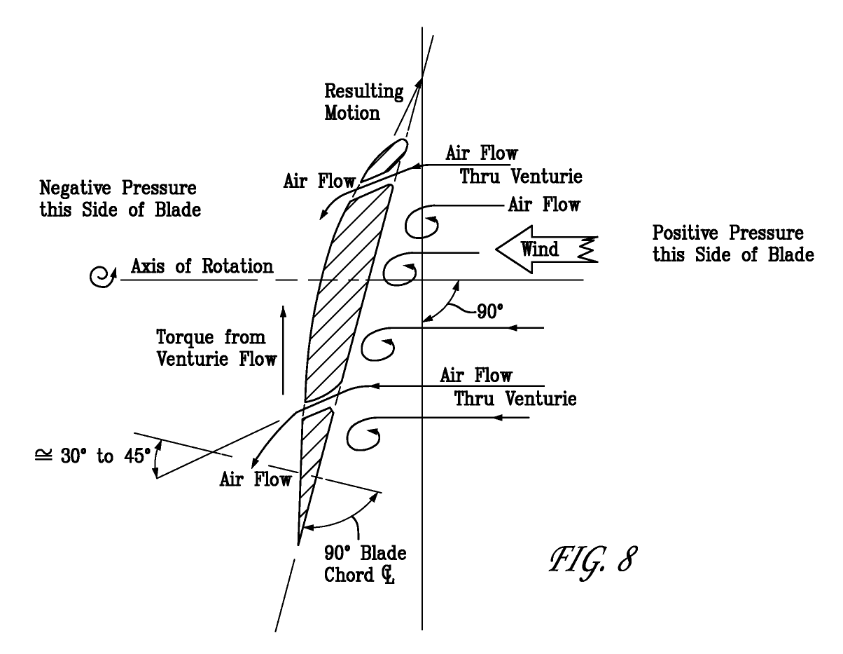

According to another embodiment, as shown in FIG. 7, the rotor blade assembly 24 includes at least two rotor blades 28 that have one or more tapered bores 122 running between their top and bottom surfaces. Such bores 122 effectively serve as thrust channels. Each bore 122 is oriented at an angle such that it independently creates a thrust tending to rotate the blade 28 by passively compressing the airstream as it passes through the blade 28 in a straight line. In an exemplary embodiment, the bores 122 are arranged in two parallel rows starting near the distal end of the rotor blade 28 and extending towards the proximal end of the blade 28. The rows preferably extend to cover about 70% of the length of the blade 28. Additionally, as shown in FIG. 8, the bores are preferably angled toward the proximal end of the blade 28 at about 30° to 45°.

While embodiments and applications of this invention have been shown and described, it would be apparent to those skilled in the art that many more modifications than mentioned above are possible without departing from the inventive concepts herein. The invention, therefore, is not to be restricted except in the spirit of the appended claims.

What is claimed is:

1. A wind turbine, comprising:
a base;
an support member rotatably mounted to the base;
an elongate body having a first end and a second end, the body pivotally mounted to a distal end of the support member at a pivot point that is offset from the axis of the base;
a rotor blade assembly coupled to a rotor shaft that is rotatably mounted to the top of the body, the rotor blade assembly including a plurality of rotor blades oriented to rotate when exposed to an airstream generated by wind;
a tail assembly mounted to the second end of the elongate body, the tail assembly including an airfoil section oriented parallel to the rotor shaft and at least one upright vane having an angular rudder, the angular rudder offset to generate a wind-induced torque in a direction opposite to a gyroscopic torque generated by rotation of the rotor blade assembly;
an alternator coupled to the rotor shaft, the alternator having a power output that varies as a function of angular velocity of the rotor shaft;
the pivot point located at a position along the length of the body such that a force exerted by the airstream on the airfoil section of the tail assembly will tilt the body about the pivot to change the cross-sectional area of the rotor blades exposed to the airstream such that the rotor shaft rotates at a substantially constant angular velocity;
an annular ratchet disposed on the base, the ratchet including a plurality of ratchet teeth, the ratchet teeth each having a flat side and a slanted side;
a flag assembly including a control vane mounted to a distal end of an angled extension shaft and a pawl mounted to a proximal end of the extension shaft, the flag assembly pivotally coupled to a proximal end of the support member such that it can rotate around the axis of the base in two directions, a restricted direction in which the pawl is stopped by the flat side of the ratchet teeth, and an unrestricted direction in which the pawl freely passes over the slanted side of the ratchet teeth;
the flag assembly oriented such that when the wind strikes the front end of the body head-on, the control vane engages the pawl with the flat side of the ratchet teeth and resists rotation, and when the wind rotates the second end of the body in the restricted direction, the control vane disengages the pawl from the flat side of the ratchet teeth and permits rotation in the restricted direction, and when the wind rotates the second end of the body in the unrestricted direction, the control vane urges the pawl into contact with the slanted sides of the successive ratchet teeth as the body rotates in the unrestricted direction.

2. The wind turbine of claim 1 wherein the plurality of rotor blades is three.

3. The wind turbine of claim 1 wherein the number of upright vanes is two.

4. The wind turbine of claim 1 wherein each angular rudder has an offset of about 30°.

5. The wind turbine of claim 1 wherein the rotor blades incorporate a progressive negative twist starting from about 8° to about 30° at the proximal end of the blade and reaching about 0° at the distal end of the blade.

6. A wind turbine, comprising:
a base;
a support member rotatably mounted to the base;
an elongate body having a first end and a second end, the body pivotally mounted to a distal end of the support member at a pivot point that is offset from the axis of the base;
a rotor blade assembly coupled to a rotor shaft that is rotatably mounted to the top of the body, the rotor blade assembly including a plurality of rotor blades oriented to rotate when exposed to an airstream generated by wind;
a tail assembly mounted to the second end of the elongate body, the tail assembly including an airfoil section oriented perpendicular to the rotor shaft and at least one upright vane having an angular rudder, the angular rudder offset to generate a wind-induced torque in a direction opposite to a gyroscopic torque generated by rotation of the rotor blade assembly;
an alternator coupled to the rotor shaft, the alternator having a power output that varies as a function of angular velocity of the rotor shaft;
the pivot point located at a position along the length of the body such that a force exerted by the airstream on the airfoil section of the tail assembly will tilt the body about the pivot to change the cross-sectional area of the rotor blades exposed to the airstream such that the rotor shaft rotates at a substantially constant angular velocity;
the rotor blade assembly including a plurality of rotor blades, at least one rotor blade having one or more tapered bores running between its top and bottom surfaces; each bore oriented at an angle to independently create a thrust tending to rotate the blade by passively compressing the airstream as it passes through the blade in a straight line;

7. The wind turbine of claim 6 wherein the plurality of rotor blades is three.

8. The wind turbine of claim 6 wherein the number of upright vanes is two.

9. The wind turbine of claim 6 wherein each angular rudder has an offset of about 30°.

10. The wind turbine of claim 6 wherein the rotor blades incorporate a progressive negative twist starting from about 8° to about 30° at the proximal end of the blade and reaching about 0° at the distal end of the blade.

11. The wind turbine of claim 6 wherein the tapered bores are angled toward the proximal end of the blade at about 30° to about 45°.

12. A wind turbine, comprising:
a base;
a support member rotatably mounted to the base;
an elongate body having a first end and a second end, the body pivotally mounted to a distal end of the support member at a pivot point that is offset from the axis of the base;
a rotor blade assembly coupled to a rotor shaft that is rotatably mounted to the top of the body, the rotor blade assembly including a plurality of rotor blades oriented to rotate when exposed to an airstream generated by wind;
a tail assembly mounted to the second end of the elongate body, the tail assembly including an airfoil section oriented parallel to the rotor shaft and at least one upright vane having an angular rudder, the angular rudder offset to generate a wind-induced torque in a direction opposite to a gyroscopic torque generated by rotation of the rotor blade assembly;
an alternator coupled to the rotor shaft, the alternator having a power output that varies as a function of angular velocity of the rotor shaft;
the pivot point located at a position along the length of the body such that a force exerted by the airstream on the airfoil section of the tail assembly will tilt the body about the pivot to change the cross-sectional area of the rotor blades exposed to the airstream such that the rotor shaft rotates at a substantially constant angular velocity;
the plurality of rotor blades each including a short inclined distal region, the inclined distal region having a height of up to 12% of the length of the tip chord and an angle of attack of less than 90° above the plane of the blade.

13. The wind turbine of claim 12 wherein the plurality of rotor blades is three.

14. The wind turbine of claim 12 wherein the number of upright vanes is two.

15. The wind turbine of claim 12 wherein each angular rudder has an offset of about 30°.

16. The wind turbine of claim 12 wherein the rotor blades incorporate a progressive negative twist starting from about 8° to about 30° at the proximal end of the blade and reaching about 0° at the distal end of the blade.

17. The wind turbine of claim 12 wherein the tapered bores are angled toward the proximal end of the blade at about 30° to about 45°

18. The wind turbine of claim 12 wherein the inclined distal region of each rotor blade has an angle of attack of about 30° above the plane of the blade.
